(19) United States
(12) Patent Application Publication
(10) Pub. No.: US 2014/0118334 A1
(43) Pub. Date: May 1, 2014

(54) 3D VISUALIZATION OF BOREHOLE DATA

(71) Applicants: Peter J. Guijt, Spring, TX (US); William W. Scott, The Woodlands, TX (US); Joel W. Tarver, Houston, TX (US)

(72) Inventors: Peter J. Guijt, Spring, TX (US); William W. Scott, The Woodlands, TX (US); Joel W. Tarver, Houston, TX (US)

(21) Appl. No.: 13/661,427

(22) Filed: Oct. 26, 2012

(51) Int. Cl. G06T 17/00

(52) U.S. Cl. 345/419

(57) ABSTRACT

A visualization system enables visualization of data obtained over a range of time values at a range of depth values in a borehole. The visualization system includes a processor configured to process the pressure data based on user input and instructions and provide output for display on a display device, and a computer-readable medium configured to store the instructions, the instructions including commands to output a first output of a three-dimensional arrangement of the pressure data.

### BACKGROUND

In the exploration and production of hydrocarbons, measurements in the borehole and formation performed by various sensors and other measurement devices are essential for making decisions about the drilling process and about the formation. The sensors and measurement devices may determine density, temperature, porosity, and various other parameters. As an example, transient analysis (analysis over time) of pressure is one type of measurement that provides useful insight into the condition and formations of a borehole. Pressure transient analysis generates a large volume of data that previously required a high level of experience and expertise to analyze efficiently. Thus, visualization systems and methods to make such large volumes of information readily accessible would be appreciated by the drilling industry.

### BRIEF SUMMARY

According to an aspect of the invention, a visualization system for visualizing data obtained over a range of time values at a range of depth values in a borehole includes a processor configured to process the data based on user input and instructions and provide output for display on a display device; and a computer-readable medium configured to store the instructions, the instructions including commands to output a first output of a three-dimensional arrangement of the data.

According to another aspect of the invention, a computer-implemented method of displaying data obtained over a range of time values at a range of depth values in a borehole includes a processor processing the data based on user input and instructions to provide output for display on a display device; and a computer-readable medium storing the instructions, the instructions including commands to output a first output of a three-dimensional arrangement of the data.

According to yet another aspect of the invention, a computer-readable medium stores instructions which, when processed by a processor, cause the processor to execute a method of providing output for a display of pressure data obtained over a range of time values at a range of depth values in a borehole. The method includes providing a first output of a three-dimensional arrangement of one of the one or more data arrays, the first output including the range of depth values arranged on a first axis and each value of data of the one of the one or more data arrays indicated on a second axis, perpendicular to the first axis, wherein the first output displays each value as a peg; and providing a second output of a line graph of another of the one or more data arrays on a plane defined by the first axis and the second axis.

### BRIEF DESCRIPTION OF THE DRAWINGS

The following descriptions should not be considered limiting in any way. With reference to the accompanying drawings, like elements are numbered alike:

FIG. 1 illustrates a cross-sectional view of an exemplary embodiment of a downhole tool disposed in a borehole penetrating the earth;

FIG. 2 is a block diagram of a visualization system according to an embodiment of the invention;

FIG. 3 illustrates an output of the visualization system according to an embodiment of the invention;

FIG. 4 illustrates an output of the visualization system according to another embodiment of the invention;

FIG. 5 illustrates an output of the visualization system according to another embodiment of the invention; and

FIG. 6 illustrates an output of the visualization system according to another embodiment of the invention.

### DETAILED DESCRIPTION

A detailed description of one or more embodiments of the disclosed apparatus and method presented herein by way of exemplification and not limitation with reference to the Figures.

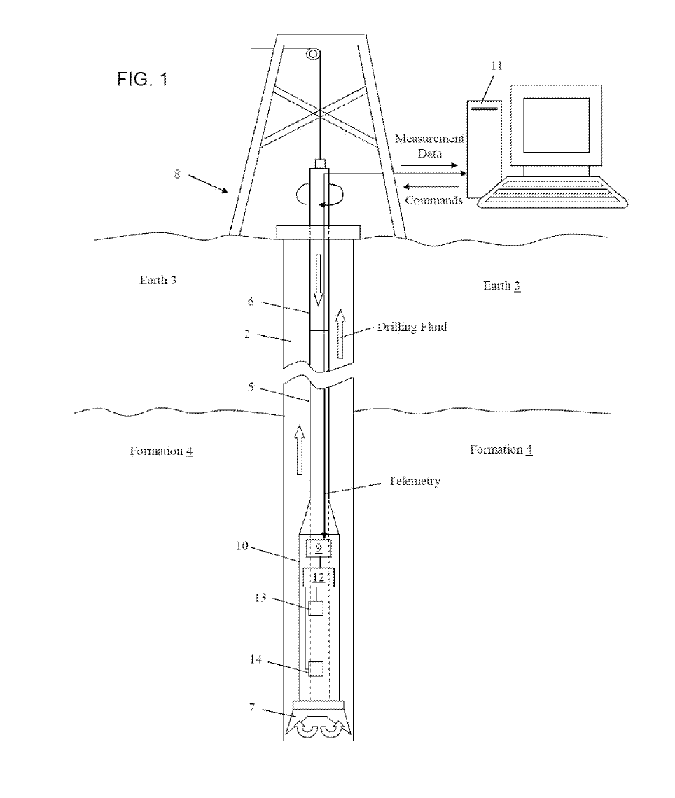

FIG. 1 illustrates a cross-sectional view of an exemplary embodiment of downhole tools 10 disposed in a borehole 2 penetrating the earth 3. The formation 4 represents any subsurface material of interest. The downhole tools 10 are conveyed through the borehole 2 by a carrier 5. In the exemplary embodiment shown by FIG. 1, the carrier 5 is a drill string 6 in an embodiment known as logging-while-drilling (LWD). Disposed at a distal end of the drill string 6 is a drill bit 7. A drilling rig 8 is configured to conduct drilling operations such as rotating the drill string 6 and thus the drill bit 7 in order to drill the borehole 2. In addition, the drilling rig 8 is configured to pump drilling fluid through the drill string 6 in order to lubricate the drill bit 7 and flush cuttings from the borehole 2. In alternate embodiments, the carrier 5 may be an armored wireline in an embodiment known as wireline logging. In either case, the downhole tools 10 measure various parameters that may be processed by downhole electronics 9. The measured data may instead or additionally be processed by a computer processing system 11 disposed at the surface of the earth 3. The computer processing system 11 may process recorded data in a post-processing environment or data may be transmitted to the computer processing system 11 via a telemetry interface while the downhole tools 10 are collecting measurements. In alternate embodiments, the computer processing system 11 may issue commands regarding the drilling process, further measurements and the like based on the data that is receives. The downhole tools 10 may record electrical, radioactive, magnetic, and other properties at different depths. Exemplary downhole tools 10 include a pressure transducer 12, density tool 13, and magnetic resonance imaging tool 14. The pressure transducer 12 provides pressure data at various depths of the borehole 2 over a period of time. In pressure transient analysis, depth, time, and pressure are all recorded. It should be understood that the downhole tools 10 could also include any number of sensors and measurement devices that work alone or in combination with each other.

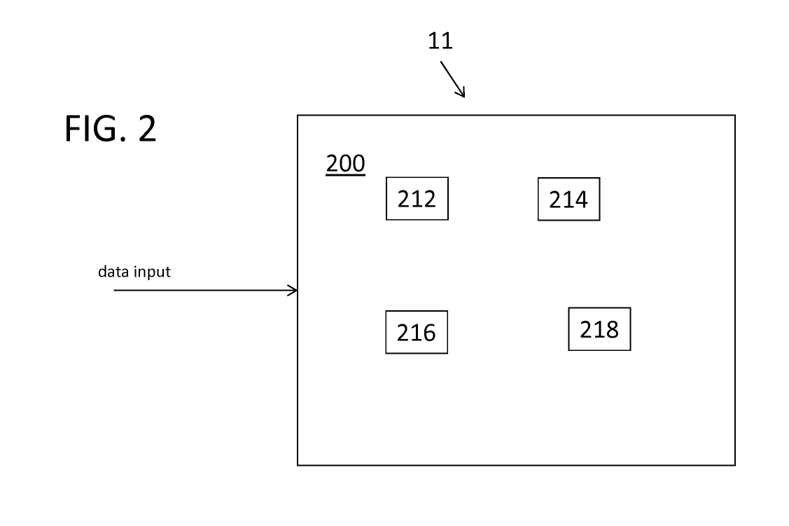

FIG. 2 is a block diagram of a visualization system 200 according to an embodiment of the invention. The visualization system 200 includes one or more memory devices 212, one or more processors 214, a user interface 216, and an output device 218 that includes a display. In one or more embodiments, the visualization system is the computer processing system 11 shown at FIG. 1. The one or more memory devices 212 and one or more processors 214 communicate with each other and with the other parts of the visualization system 200 wirelessly or via one or more buses. As such, the different parts 212, 214, 216, and 218 may not be housed together but, instead, for example, the processor 214 may transmit processed data to the display device 218 over a network for display at a different location. The one or more memory devices 212 store one or more applications that, when executed by the processor 214, process the incoming data and provide output in a format for display by the display device 218. While several of the different types of applications are detailed below with specific reference to the exemplary case of the data being pressure transient analysis data, any data collected at different depths and at different times may be processed in a similar manner.

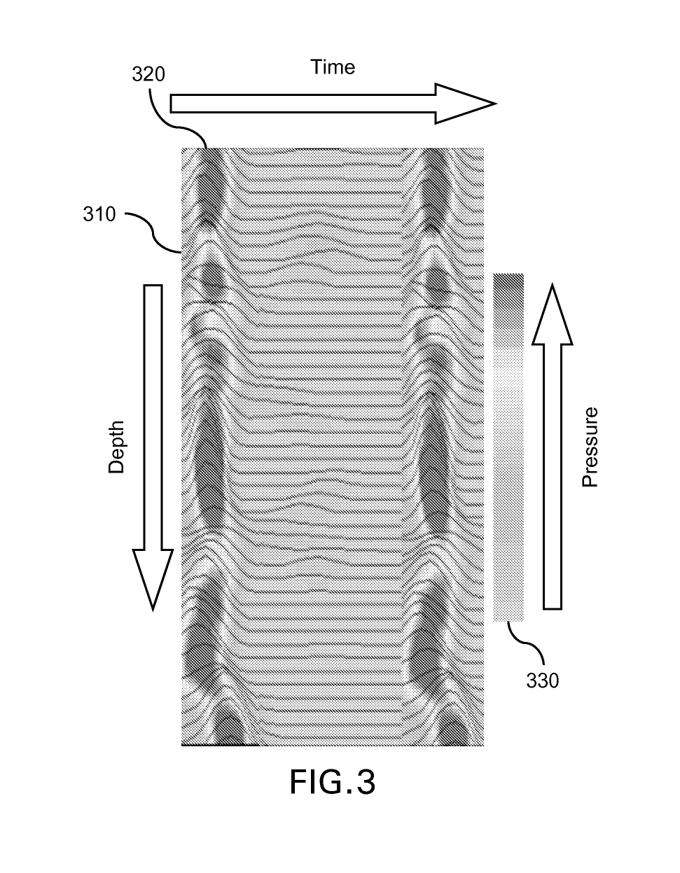

FIG. 3 illustrates an output of the system 200 according to an embodiment of the invention. In this embodiment, exemplary pressure transient analysis data is visualized in a three-dimensional image with the third dimension being represented by a coded value. In FIG. 3, depth is shown on one axis 310, time is shown on another axis 320, and pressure at each depth over time is shown as a coded value 330 for each depth and time. For example, the coded value 330 may be color coded or coded in gray-scale, as shown, in a gray-scale variable density image. Although depth is shown as increasing in the downward direction in FIG. 3, alternate embodiments contemplate depth values increasing in the opposite direction and also the axes 310, 320 of the depth and time values being switched.

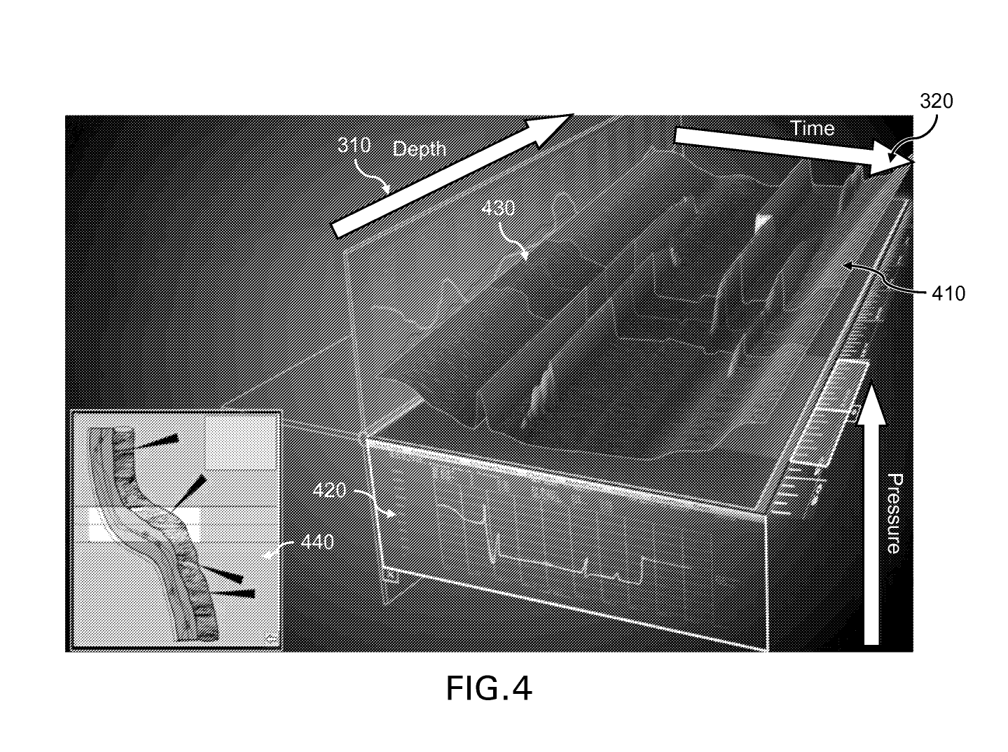

FIG. 4 illustrates an output of the visualization system 200 according to another embodiment of the invention. In this embodiment, exemplary pressure transient analysis data is visualized as a topographical image 410 with a two-dimensional cross-sectional image 420 shown at a selected depth 430. The topographical image 410 shows depth on one axis 310, time on another axis 320, and pressure as a height in a plane perpendicular to the plane formed by the depth axis 310 and time axis 320. The selected depth 430 at which the two-dimensional cross-sectional image 420 of pressure values over time is displayed may change automatically at a preset speed (e.g., as a sliding scale) or may be selected randomly from any of the depth 310 values by a user. The preset speed may be set by a user at the time of display or may be a predetermined default speed. A third image may additionally be available to show a cross-sectional view of the borehole 440 for the entire range of depth 310 values. This cross-sectional view of the borehole 440 may indicate the selected depth 430 giving rise to the two-dimensional cross-sectional image 420. With the combination of the three images 410, 420, and 440, a user can readily appreciate the location of the selected depth 430 within the borehole 2 and ascertain the pressure changes over time at that depth.

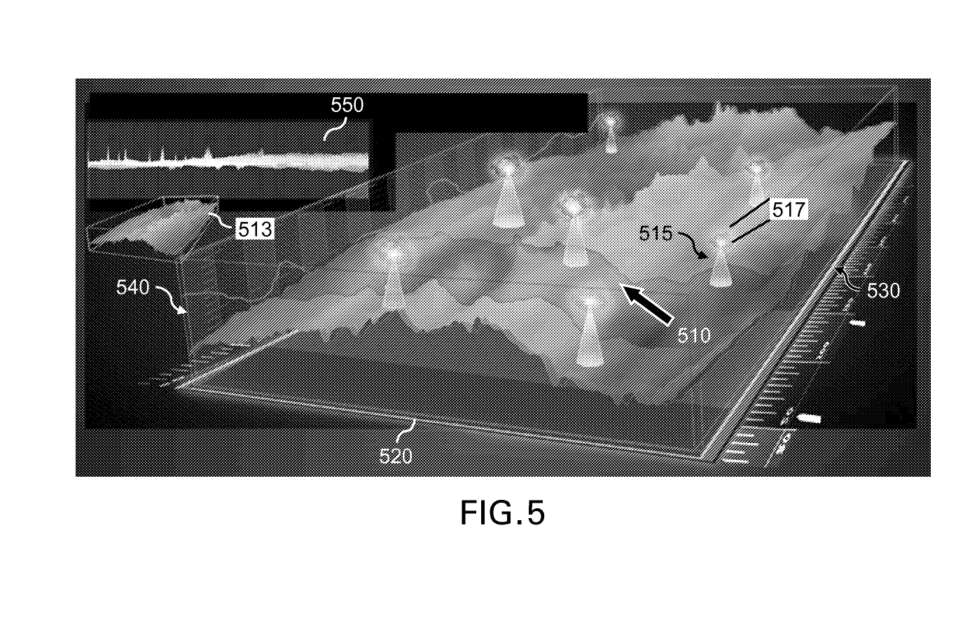

FIG. 5 illustrates an output of the visualization system 200 according to another embodiment of the invention. In an exemplary embodiment, data (one or more arrays of values over a range of depths or times) is visualized as a variable color (or pattern) density terrain graph 510. The data terrain graph 510 may be rotated in any direction, as shown by the rotated density terrain graph 513, for example. The data terrain graph 510 may also be scrolled up and down in depth or time (z-axis 530). That is, a fixed size for the depth or time range (displayed on the z-axis 530) may be set by a user through the user interface 216 of the visualization system 200 but the depth or time values displayed at a given depth or time may be changed by scrolling in one direction (increasing depth or time values) or the other (decreasing depth or time values). Beacons 515 may be used as markers or bookmarks for certain time, depth and value sets, or other metadata such as photographs, data images, sound recordings or comments pertaining to the bookmarks' depth or time indices. When a user selects one of the beacons 515, additional information 517 related to the beacon value may be displayed or otherwise output by the output device 218. The exemplary data may be, for example, pressure transient analysis data indicating pressure value (y-axis 540) at a given depth (z-axis 530) at a given time. A variable density topology graph 550 may also be included in the display according to the present embodiment. The density terrain graph 510 and variable density topology graph 550 may indicate values or ranges of values by color or pattern.

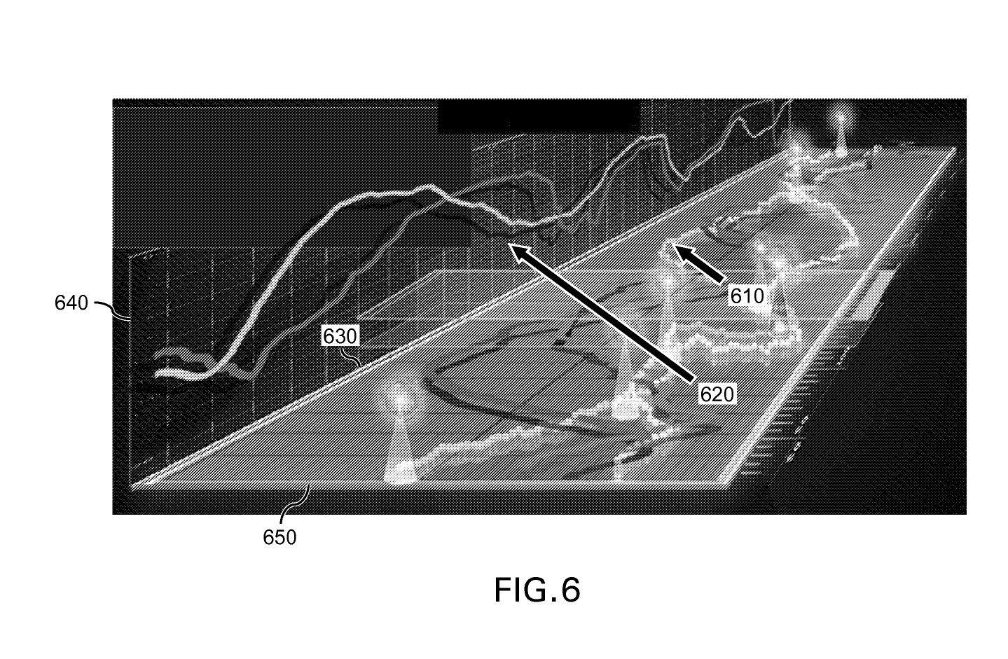

FIG. 6 illustrates an output of the visualization system 200 according to another embodiment of the invention. In this embodiment, data (one or more arrays of values over a range of depths or times) is visualized as a peg graph 610 with pegs indicating a value (on the x-axis 650) and extending in the y-axis 640 dimension. A two-dimensional line graph 620 is also shown over the depth or time axis (z-axis 630). Values are indicated on the y-axis 640 for the line graph 620. The data may include more than one array of values. That is, for example, density may be indicated by one peg graph 610 (one array of values) while porosity is depicted by another peg graph 610 (another array of values). Any of the parameters measured by the downhole tools 10 may be displayed according to the embodiment described herein. The same or different values may be illustrated by the line graphs 620. The line graphs 620 may be additionally included on the plane (defined by the x-axis 650 and z-axis 630) that includes the peg graphs 610. Each array of values may be identified by a different color or pattern. An operator using the user interface 216 of the visualization system 200 may determine the values and types of graphs for each value to be visualized. Beacons 660 may be used as markers or bookmarks for certain values. When a user selects one of the beacons 660, additional information regarding the data at that point may be displayed or otherwise output by the output device 218. For example, by selecting a beacon 660 relating to a pressure data at a given time interval, the user may be shown a comment entered about that pressure data value by another operator or a corresponding cross-sectional view of the borehole 440.

While one or more embodiments have been shown and described, modifications and substitutions may be made thereto without departing from the spirit and scope of the invention. Accordingly, it is to be understood that the present invention has been described by way of illustrations and not limitation.

In support of the teachings herein, various analysis components may be used, including a digital and/or an analog system. For example, the downhole electronics 9 or the computer processing system 11 may include digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A visualization system for visualizing data obtained over a range of time values at a range of depth values in a borehole, the system comprising:
a processor configured to process the data based on user input and instructions and provide output for display on a display device; and
a computer-readable medium configured to store the instructions, the instructions including commands to output a first output of a three-dimensional arrangement of the data.

2. The system according to claim 1, wherein the processor provides the first output such that the range of time values is shown on a first axis, the range of depth values is shown on a second axis, perpendicular with the first axis, and each value of the data is displayed based on a code at each respective time and depth value.

3. The system according to claim 2, wherein the code defines a color associated with each value or range of values of the data or a gray-scale variable density display.

4. The system according to claim 1, wherein the data is pressure transient analysis data.

5. The system according to claim 1, wherein the computer-readable medium further instructs the processor to provide a second output of a two-dimensional cross-sectional image of the first output showing the data over the range of time values at a selected depth value within the range of depth values.

6. The system according to claim 5, wherein each depth value in the range of depth values is set as the selected depth value automatically at a selected rate or is selected by a user.

7. The system according to claim 5, wherein the computer-readable medium further instructs the processor to provide a third output of a cross-sectional image showing the range of depth values and indicating the selected depth value.

8. The system according to claim 1, wherein the computer-readable medium further instructs the processor to display one or more beacons at one or more corresponding data values, wherein when a user selects one of the one or more beacons, additional information is displayed.

9. A computer-implemented method of displaying data obtained over a range of time values at a range of depth values in a borehole, the method comprising:
a processor processing the data based on user input and instructions to provide output for display on a display device; and
a computer-readable medium storing the instructions, the instructions including commands to output a first output of a three-dimensional arrangement of the data.

10. The method according to claim 9, wherein the processor providing the first output includes arranging the range of time values on a first axis, the range of depth values on a second axis, perpendicular to the first axis, and each value of the data based on a code at each respective time and depth value.

11. The method according to claim 10, wherein the code defines a color associated with each value or range of values of the data or a gray-scale variable density display.

12. The method according to claim 10, wherein the data is pressure transient analysis data.

13. The method according to claim 9, wherein the computer-readable medium storing the instructions includes storing instructions to provide a second output of a two-dimensional cross-sectional image of the first output showing data over the range of time values at a selected depth value within the range of depth values.

14. The method according to claim 13, wherein each depth value in the range of depth values is set as the selected depth value automatically at a selected rate or is selected by a user.

15. The method according to claim 13, wherein the computer-readable medium storing the instructions includes storing instructions to provide a third output of a cross-sectional image showing the range of depth values and indicating the selected depth value.

16. The method according to claim 8, wherein the computer-readable medium storing the instructions includes storing instructions to display one or more beacons at one or more corresponding data values, wherein when a user selects one of the one or more beacons, additional information is displayed.

17. A computer-readable medium storing instructions which, when processed by a processor, cause the processor to execute a method of providing output for a display of one or more data arrays obtained over a range of depth or time values in a borehole, the method comprising:
providing a first output of a three-dimensional arrangement of one of the one or more data arrays, the first output including the range of depth or time values arranged on a first axis and each value of data of the one of the one or more data arrays indicated on a second axis, perpendicular to the first axis, wherein the first output displays each value as a peg; and
providing a second output of a line graph of another of the one or more data arrays on a plane defined by the first axis and the second axis.

18. The method according to claim 17, wherein the computer-readable medium storing the instructions includes storing instructions to display one or more beacons at one or more corresponding values, wherein when a user selects one of the one or more beacons, additional information is displayed.

19. The method according to claim 17, wherein the computer-readable medium storing the instructions includes storing instructions to provide a third output on a plane perpendicular to the plane defined by the first axis and the second axis.

20. The method according to claim 19, wherein the third output is a line graph of one of the one or more data arrays obtained in the borehole.
